(19) United States
(12) Patent Application Publication
(10) Pub. No.: US 2024/0165630 A1
(43) Pub. Date: May 23, 2024

(54) AGITATOR MILL COMPRISING BASKET WITH THICKENING

(71) Applicant: NETZSCH-Feinmahltechnik GmbH, Selb (DE)

(72) Inventors: Robert Grandl, Selb (DE); Lars-Peter Weiland, Schönwald (DE); Holger Moeschl, Selb (DE); Witali Sudermann, Marktredwitz (DE)

(21) Appl. No.: 18/509,449

(22) Filed: Nov. 15, 2023

(30) Foreign Application Priority Data
Nov. 17, 2022 (DE) 10 2022 130 384.5

(51) Int. Cl. B02C 17/16

(52) U.S. Cl. CPC B02C 17/163

(57) ABSTRACT

Agitator mill including a grinding chamber containing grinding bodies and an agitator shaft, which revolves therein about a horizontal agitator shaft axis, which supports several grinding members, which are connected to it in a rotationally fixed manner and which are spaced apart from one another in the direction of the horizontal axis, preferably in the shape of grinding disks, which move the grinding bodies, whereby, on the outlet side, the agitator shaft has a basket, which is preferably studded with grinding members on its outer circumference and which overlaps the split tube-supporting outlet, characterized in that in the region of its free end, the basket has a section with an enlarged outer diameter.

### TECHNICAL FIELD

The invention relates to an agitator mill comprising a basket with a thickening as well as the corresponding basket claims.

### BACKGROUND

The basic principle of an agitator mill will initially be described on the basis of FIG. 1.

An agitator mill 1 comprising a horizontal agitator shaft 3 is illustrated schematically in FIG. 1. The illustration of the grinding bodies, which are located in the grinding container 16 and which are generally embodied as steel or ceramic balls, was forgone.

During the operation of the agitator mill 1, the material to be ground is pumped via the inlet 17 of the agitator mill 1 into or through the grinding chamber 2, respectively, which is enclosed by the grinding container 16. In the case of the wet grinding, the material to be ground is a suspension or dispersion, respectively, of a liquid, mostly in the shape of water, and solids. In other cases, such an agitator mill 1 can also be used for the dry grinding. It can then be designed for instance as agitator mill comprising a vertical shaft, through which the grinding material is carried by a gaseous fluid, mostly in downflow.

In its broadest aspect, the present invention relates to both types of agitator mills. Its use is particularly preferred in the case of agitator mills comprising a horizontal agitator shaft 3.

The grinding members 5, which are connected in a rotationally fixed manner to the agitator shaft 3 and which are often also embodied and referred to as grinding disks, are set into rotation by means of a rotational movement of the agitator shaft 3. The formation of the grinding members 5 in the form of individual pins is likewise possible, also as part of the invention, which will be described below. To create the rotational movement, the agitator shaft 3 can be driven, for example, via a belt drive 102 by means of an electric motor 101. The drive of the agitator mill 1 is thereby mostly located in a housing 103 adjacent to the grinding container 16.

Due to the rotation of the grinding members 5, the grinding bodies, which are located in the grinding chamber 2 and which are located in the vicinity of the grinding members 5, are entrained in the circumferential direction of the grinding container 16. As soon as they have reached the apex region, the moved grinding bodies flow back in the direction of the agitator shaft 3 again in the central region between two respective grinding members 5. A circulation movement of the grinding bodies is thus created between two respective grinding members 5.

Collisions and roll-overs between the solids of the grinding material suspension pumped through the grinding chamber 2 and the grinding bodies is caused due to the movement of the grinding bodies. These collisions and roll-overs lead to the splintering of fine particles from the solids in the grinding material suspension, so that the solids arriving at the outlet 7 of the agitator mill 1 are ultimately significantly smaller than the solids supplied on the inlet 17.

In order to ensure that grinding bodies are not discharged from the grinding chamber 2, a screen or preferably a screen in the shape of a split tube 8, respectively, representatively referred to below as “split tube”, is mostly also attached in front of the outlet 7 and/or supported by the outlet 7. A basket 6 encompassing this split tube 8 is arranged around this split tube 8. The basket serves the purpose of preventing that damaging grinding body pressure is exerted on the split tube by the grinding bodies, which tend to be pushed in the direction of the split tube by the pressure of the feed pump.

For the most part, the basket 6 is attached in a rotationally fixed manner on the free end of the agitator shaft 3 facing the outlet 7.

The region between the circumferential basket 6 and the split tube 8 forms the separation chamber 15 because the material to be ground or the grinding material suspension, respectively, is separated from the grinding bodies here and lastly escapes from the agitator mill 1 again via the split tube 8 and the outlet 7.

As a rule, the basket 6, however, can only fulfill its function when grinding bodies, which have entered into the separation chamber 15, are able to also get out of the separation chamber again, back into the grinding chamber 2. This is so because otherwise the separation chamber 15 is quickly filled up with grinding bodies and the grinding bodies then block the split tube 8 and possibly allow it to even wear prematurely.

In order to prevent this, various apertures 14 are provided in the basket 6. Due to these apertures 14, the grinding bodies can pass from the separation chamber 15 into the grinding chamber 2 again more easily. FIG. 2 shows a basket 6, which is designed in this way, of an agitator mill, which served as comparative object in the lead-up to the invention. The grinding body and/or grinding material flows, which have already been mentioned and which take place in the grinding container 16, are illustrated schematically thereby in FIG. 2. As can be seen, the basket 6 preferably likewise supports, on its outer jacket surface, grinding members, which cause a movement or a circling, respectively, of the grinding bodies in the region between the basket and the inner wall of the grinding container 16. This circling of the grinding bodies makes it easier for the grinding bodies located in the separation chamber 15 to escape through the apertures 14 into the grinding chamber 2 again.

The inventors have determined, however, that in the case of the basket construction shown in FIG. 2, there is also still a certain tendency of the grinding bodies, which entered into the separation chamber 15, to attach tightly to the split tube 8 and to block the split tube 8 or to even cause unnecessary wear. Both negatively impacts the separation efficiency of the split tube 8. This tendency is suggested schematically by means of the arrows, which point in the direction of the split tube 8 in FIG. 2. Even though grinding bodies can also be discharged from the separation chamber 15 through the apertures 14, it is the tendency of the grinding bodies, however, to rather move towards the split tube 8.

The DE 20 2009 011 656 U1 relates to an agitator mill for wet grinding, with a change of the product flow direction away from the drive, a grinding container, which is rotated by 180°, a central split tube, which can be disassembled from the outside, comprising a circumferential spin-off catcher, and only still one seal between grinding chamber and atmosphere.

The DE 100 64 828 A1 describes an agitator mill comprising an agitator and a grinding container, which is arranged at a radial distance therefrom, whereby the grinding container and the agitator shaft limit an annularly cylindrical grinding chamber and a separating means, which is arranged in the grinding container and which holds back the auxiliary grinding bodies, whereby the separating means consists of several tubular screens, which are part of a rotating cage.

### SUMMARY

In view of this, it is the object of the invention to further improve the separation performance of the split tube.

According to the invention, this problem is solved with the features of the first main claim.

For this purpose, an agitator mill comprising a grinding chamber including grinding bodies and an agitator shaft, which revolves therein about a horizontal agitator shaft axis, is assumed. The agitator shaft supports several grinding members, which are connected to it in a rotationally fixed manner and which are spaced apart from one another in the direction of the horizontal axis. These grinding members are preferably formed in the shape of grinding disks. During the operation of the agitator mill, they move the above-described grinding bodies.

On the outlet side, the agitator shaft has a basket thereby. This means that the basket preferably follows the agitator shaft directly and is connected directly or indirectly thereto. However, the agitator shaft and the basket are thereby preferably not formed integrally with one another, which is why agitator shaft and basket represent two individual parts, and the agitator shaft does not take over any direct tasks of the basket. In addition, the length of the basket is preferably maximally one third, particularly preferably even maximally one fourth of the length of the agitator shaft.

The basket is preferably studded with additional grinding members on its outer circumference. As already mentioned, not only an additional grinding effect can be attained thereby in the radial circumferential region between the outer circumference of the basket and the inner wall of the grinding container. In fact, that circling movement of the grinding bodies, which promotes the reemergence of the grinding bodies from the separation chamber, is in particular also created thereby. These grinding members on the basket are thereby preferably not embodied like the grinding members of the agitator shaft. While the grinding members of the agitator shaft are preferably embodied in the shape of grinding disks, the grinding members of the basket are preferably embodied in the shape of pins.

In the operation as intended, this mentioned basket at least partially overlaps the outlet, whereby the outlet supports the split tube. It is preferably the case here that the basket overlaps the split tube in its entire length. As part of these embodiments, the “split tube” in the narrower sense is preferably a tube comprising various slits and/or apertures of some other shapes, in the broader sense, however, the term “split tube” comprises any type of screen body.

As already described in a previous paragraph, a free region between the inner surface of the basket and the outer surface of the outlet or of the split tube, respectively, which is supported by the outlet, is formed by means of this overlapping arrangement of the basket. This region is referred to as “separation chamber”.

The agitator mill according to the invention is characterized in that the mentioned basket has a section with an enlarged outer diameter in the region of its free end facing the grinding chamber. This “enlarged outer diameter” thereby preferably represents an additional ring, which is embodied integrally with the basket, by means of which the outer diameter of the basket is enlarged regionally, while the outer diameter of the remaining region of the basket remains essentially constant. In the broader sense, however, the “enlarged outer diameter” also refers to an enlarging outer diameter, thus an outer diameter of the basket, which increases in sections or also over the entire length of the basket. The entire basket or sections of the basket thereby has an, e.g., essentially truncated cone-shaped outer geometry; with an outer diameter, which increases towards the free end of the basket—preferably steadily or even constantly.

This is based on the following insight of the inventors: The entrance region shown by FIG. 2 directly behind the free front surface of the basket, in which the flow flows in predominantly horizontal direction in order to enter into the separation chamber, forms a constriction, which is too pronounced. The latter is so because the basket shown in FIG. 2 forms an annular structure, which is closed in the circumferential direction, in this region.

Even though the grinding body flow theoretically attains a higher flow speed when flowing through the constriction, which would in fact be desirable, the grinding bodies are entrained in particular in the axial direction and additionally have only limited options for leaving the basket. The grinding bodies thus often crash against the basket and/or the split tube, whereby they are decelerated strongly. In addition, the constriction is often also designed to be so narrow that some grinding bodies already collide with themselves, the basket and/or the split tube at the entrance into the separation chamber and thus already initially lose kinetic energy.

When the grinding bodies finally reach the outer circumferential surface of the split tube under the apertures, they often still only have a kinetic energy, which is too low in order to evade the suction of the split tube and to use the apertures to reemerge into the grinding chamber. A portion of the grinding bodies thus comes to a standstill and accumulates on the outer circumferential surface of the split tube. The grinding body dynamics is further reduced thereby. Under unfavorable circumstances, the split tube is in danger of being blocked after some operating time.

The mentioned “grinding chamber” is thereby that chamber in the interior of the grinding container, which lies between inlet and outlet and which is filled with grinding bodies and/or grinding material or grinding material suspension, respectively, and which is simultaneously not enclosed by the basket. The grinding chamber is thus quasi the interior of the grinding container, minus the built-in components passing through it and minus the separation chamber.

This enlarged outer diameter according to the invention has the effect that the gap between the outer contour of the basket and the inner contour of the grinding container becomes narrower. This gap becomes turbulent for the most part, but is axially flown through as a result, and the constriction of this gap leads to an increased flow speed and/or to an increasing turbulence. The grinding bodies and the grinding material are thus entrained at this point with higher speed and/or under higher turbulence, and thus attain a higher kinetic energy. Grinding bodies thus flow into the separation chamber between the basket and the split tube more dynamically or at a higher speed, respectively, which has the result that, in spite of the suction, which the split tube also exerts on them, the grinding bodies are not sucked in or are sucked in to a decreased extent, respectively, in such a way that they remain on the surface of the split tube. In fact, grinding bodies can increasingly withstand the suction and are discharged from the separation chamber into the grinding chamber, preferably through the already-mentioned cavities in the basket.

An “accumulation” of the grinding bodies and/or of the material to be ground or of the grinding material suspension, respectively, at the entrance to the basket is reduced and the grinding bodies can, at least partially, enter into the separation chamber significantly more easily and with higher dynamics. A desirable flow is then created there, whereby the grinding bodies are in fact kept away from the split tube and are discharged from the separation chamber into the grinding chamber again through the slits more quickly and/or more easily. The split tube is blocked less strongly thereby and experiences less stress and/or or less wear because the grinding bodies are guided back into the grinding chamber more quickly and/or in a way, which is gentler for the split tube. Additional turbulences are created essentially in the region, in which the grinding bodies are entered directly through the slits (in particular in the region between outer circumference of the basket and the inner wall of the grinding container), and the surrounding grinding body bed is activated.

An increased grinding effect of the agitator mill can thus generally be attained, the split tube experiences a lower wear during operation, and fewer grinding bodies settle in or on the split tube.

The agitator mill can thus be operated with a higher throughput with increased service life of the basket and with lower maintenance effort.

There is a number of options for designing the invention so that its effectiveness or usability is even further improved.

A preferred embodiment of the invention is that the region with the enlarged outer diameter reaches directly to the free front end of the basket. The increased flow speed thus does not decrease too soon again because the grinding bodies preferably maintain this increased movement energy all the way into the region of the separation chamber.

It is furthermore particularly preferred when the section with the enlarged outer diameter has an essentially or preferably completely smooth jacket surface outside of the ramp, which is possibly formed by it, whereby this smooth jacket surface can be intersected by webs and/or apertures.

It is particularly favorable when the agitator mill is characterized in that the section with the enlarged outer diameter, including the ramp, which is possibly formed by it, in the direction along the agitator shaft axis, accounts for only between 45% and 20%, better for only between 30% and 25%, of the length of the basket in the direction of the agitator shaft axis. It is avoided thereby that the enlarged outer diameter as a whole develops a throttling effect, which is too strong, thus increases the flow resistance so far that the goal of forming a flow, which allows for the grinding bodies to enter into the separation chamber more dynamically than before, is counteracted.

It is particularly favorable when the section with the enlarged outer diameter, outside of the ramp, which is possibly formed by it and outside of the grinding pins supported by it, has a smooth jacket surface. This likewise contributes to not excessively increasing the flow resistance.

On its circumferential jacket surface, the section with the enlarged outer diameter ideally supports grinding members, but preferably in the shape of grinding rods, ideally in the shape of at least one ring of grinding rods, which are set up one behind the other in the circumferential direction. Grinding rods of this type contribute to increasing the grinding body dynamics in the sense that grinding bodies can escape more easily from the grinding chamber again. Grinding rods, compared to grinding disks, thereby have the large advantage at this point of not excessively increasing the flow resistance, in turn.

### BRIEF DESCRIPTION OF THE DRAWINGS

FIG. 1 shows an agitator mill according to the prior art from cut side view.

FIG. 2 shows the grinding container of an agitator mill from cut side view, whereby the basket has apertures for house-internal considerations.

FIG. 3 shows a first exemplary embodiment of the basket according to the invention in side view.

FIG. 4 shows the exemplary embodiment of the basket according to the invention from FIG. 3 in three-dimensional view.

FIG. 5 shows a second exemplary embodiment of the basket according to the invention in side view.

FIG. 6 shows the exemplary embodiment of the basket according to the invention from FIG. 5 in three-dimensional view.

FIG. 7 shows the grinding container of an agitator mill from cut side view with a third exemplary embodiment of the basket according to the invention.

### DETAILED DESCRIPTION

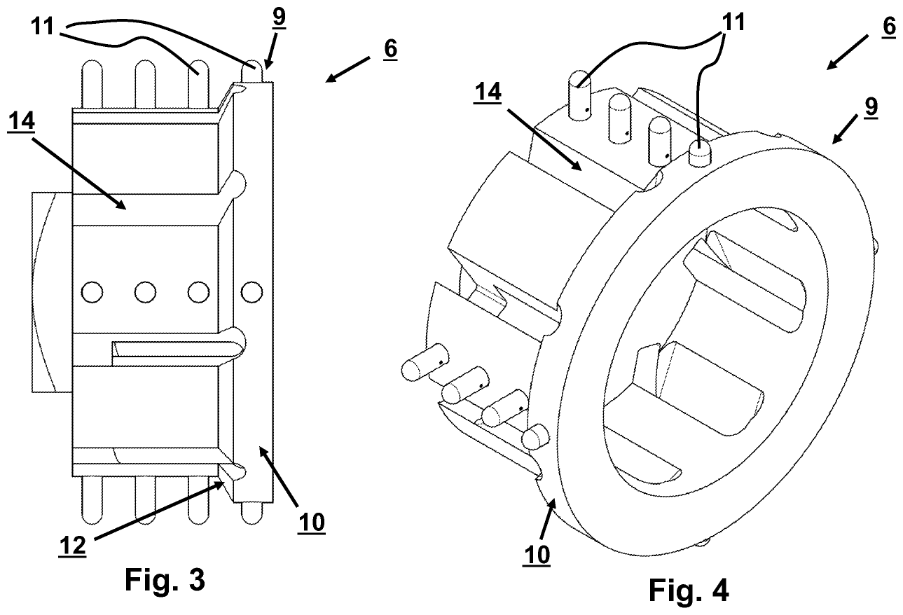

FIG. 3 and FIG. 4 initially show a first preferred exemplary embodiment of the basket 6 according to the invention in different views.

On its outer circumference, the basket 6 is thereby studded with additional grinding members 11, which are attached regularly over the circumference of the basket 6 in the shape of pins in horizontal rows, which run parallel to the agitator shaft axis 4.

The basket 6 also comprises several apertures 14, which have already been mentioned above, by means of which grinding bodies can be discharged from the separation chamber into the grinding chamber. This exemplary embodiment of the basket 6 supports a preferred section 10 with enlarged outer diameter, whereby this section 10 is formed integrally with the basket 6 on the free end 9 thereof and reaches all the way to the front side of the free end 9 of the basket 6. The section 10 with enlarged outer diameter thereby preferably has a ramp 12, which leads from the outer diameter of the basket 6, which is essentially constant regionally, to the outer diameter of the section 10, which is essentially constant regionally. This section 10 preferably also has additional grinding members 11, preferably in the shape of pins or rods, respectively. All of the free ends of the additional grinding members 11 on the basket 6 thereby preferably end essentially at the same diameter and so as to preferably be aligned with the other pins of the basket, which have already been described above, mostly parallel to the agitator shaft axis 4.

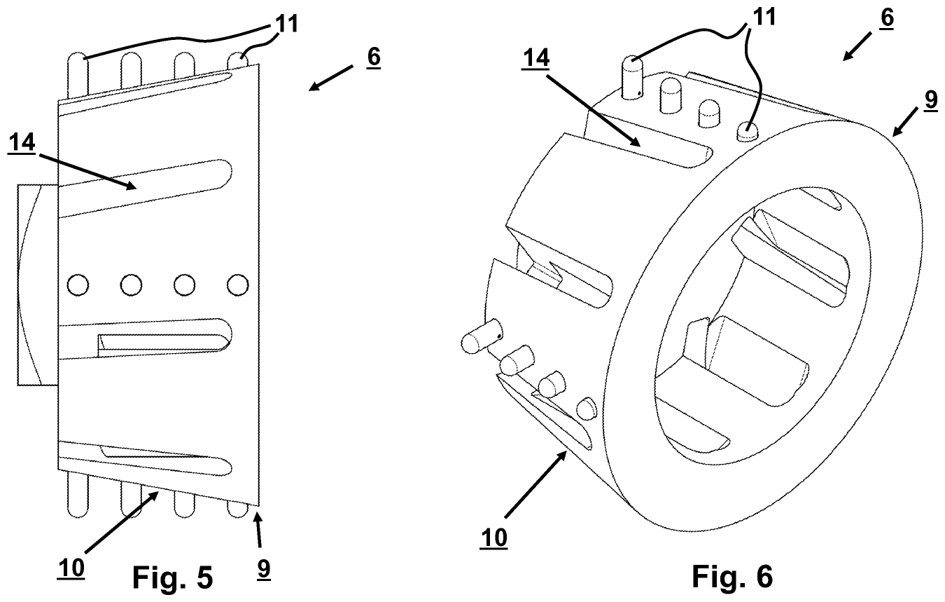

FIG. 5 and FIG. 6 show a second preferred embodiment of the basket 6 in different views, whereby the section 10 with enlarged outer diameter is an outer diameter, which preferably enlarges continuously towards its free end 9 in sections.

In the case of the exemplary shown here, the basket 6 thus has a truncated cone-shaped outer geometry in sections—without the fastening sleeve for the agitator shaft 3. On its outer circumference, the basket 6 is thereby studded, in turn, with additional grinding members 11, which are attached regularly over the circumference of the basket 6 in the shape of pins in horizontal rows, which run parallel to the agitator shaft axis 4.

The basket 6 also comprises several of the apertures 14, which have already been mentioned above, through which grinding bodies can be discharged from the separation chamber into the grinding chamber. All of the free ends of the additional grinding members 11 on the basket 6 thereby preferably also end essentially at the same diameter and so as to preferably be aligned with the other pins of the basket, which have already been described above, mostly parallel to the agitator shaft axis 4. In addition, these additional pins or rods 11, respectively, are preferably arranged so that the longitudinal axis of the rods 11 intersects essentially orthogonally with the agitator shaft axis 4.

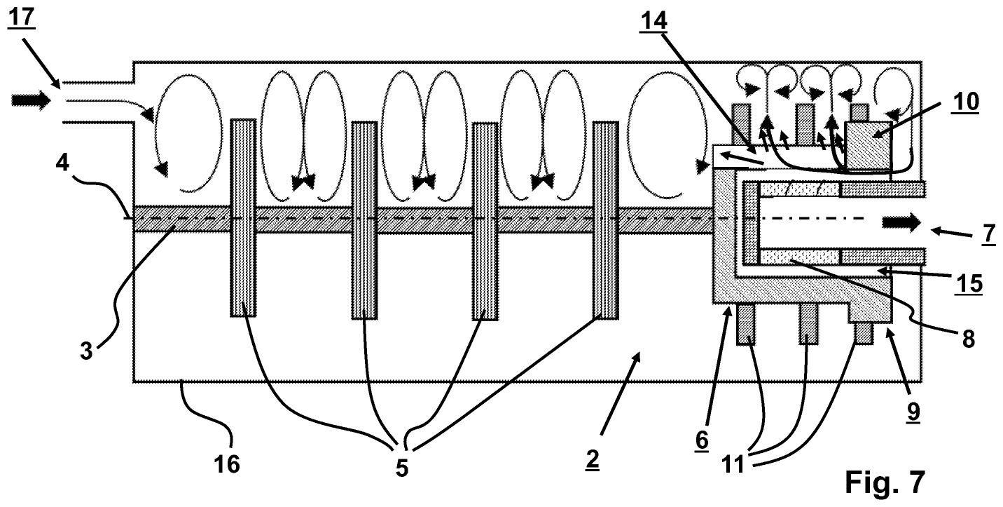

Lastly, FIG. 7 shows a further preferred embodiment of the basket 6, whereby the basket 6, in turn, supports a section 10 with enlarged outer diameter, but without an additional ramp 12 here.

In addition, FIG. 7 schematically shows the flow behavior in the grinding container 16 of an agitator mill 1, in principle representative for all of the exemplary embodiments described so far.

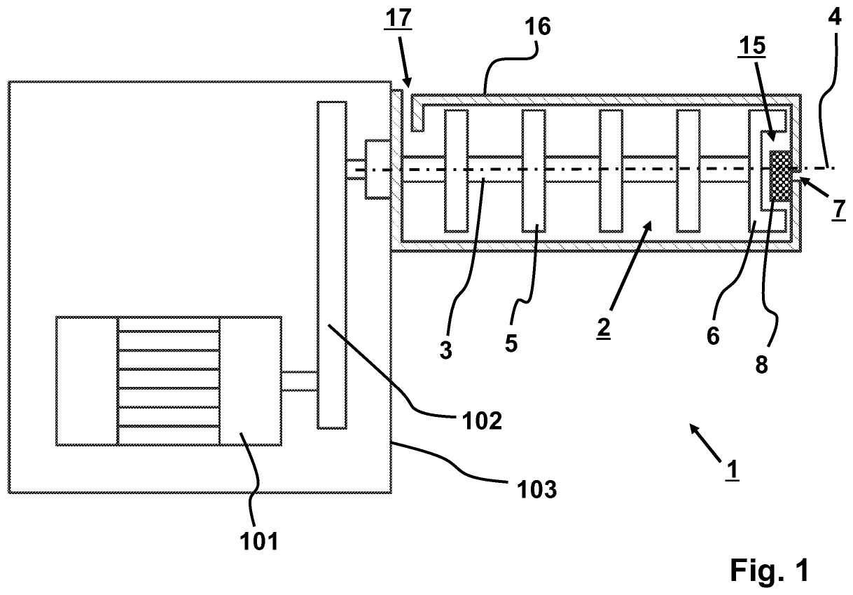

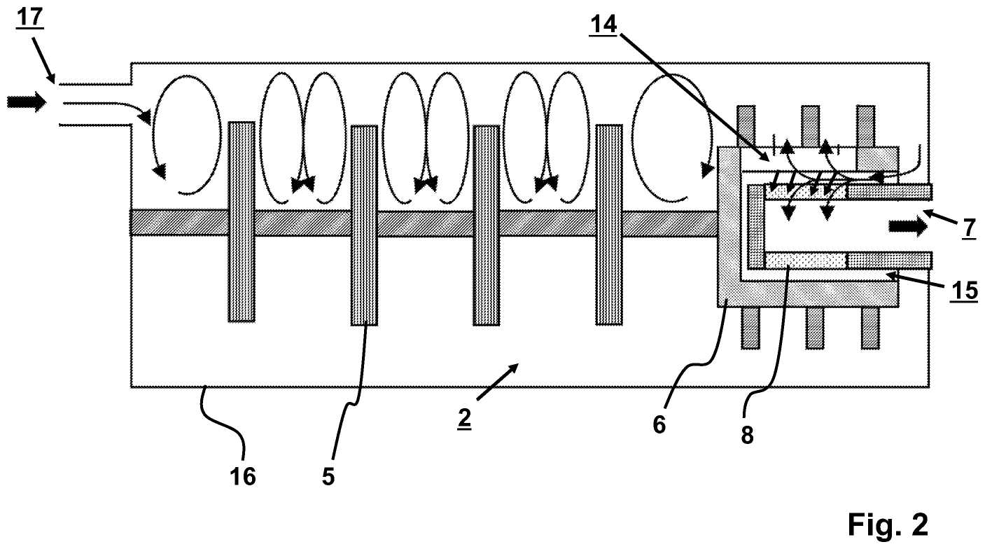

Reference is initially made at this point to the general mode of operation of an agitator mill, which has been described with the help of FIG. 1 and FIG. 2 in the paragraph “Technical Background”. The basic function and the flow behavior are identical or similar, respectively, to the region of the basket 6 and will thus not be repeated once again at this point.

Due to the constriction of the radial gap between the section 10 with enlarged outer diameter and the inner wall of the grinding container 16, the local flow speed increases (as mentioned) and/or an increased turbulence occurs. This is suggested schematically in FIG. 7 by means of the additional turbulence on the outlet side of the grinding container 16, which quasi forms a “9”.

Grinding bodies and/or the grinding material suspension can thereby enter into the separation chamber 15 more easily or more dynamically, respectively. The tendency of the grinding bodies of not being able to evade the suction of the screen/split tube and to thus accumulate permanently or long-term on the outer circumferential surface of the split tube and to block it, thus decreases. Instead, the grinding bodies are discharged from the separation chamber 15 into the grinding chamber 2 through the apertures 14 more quickly again by the flow, which is formed to be more active according to the invention. This is suggested in FIG. 7 by means of the additional arrows, which point from the shown aperture 14 into the grinding chamber 2. In addition, an additionally intensified flow also forms due to the higher flow speeds and/or turbulences in the radial region between the outer circumference of the basket 6 and the inner wall of the grinding container 16, preferably between the grinding members 11, whereby the surrounding grinding body bed is also activated additionally. The grinding bodies are thus rather kept away from the split tube 8 or the split tube-supporting outlet 7, respectively, or are discharged from the separation chamber 15, respectively, and lead to an increased grinding effect in the grinding chamber 2 after the discharge from the separation chamber 15.

1. An agitator mill comprising a grinding chamber including grinding bodies and an agitator shaft, which revolves therein about a horizontal agitator shaft axis, which supports several grinding members, which are connected to it in a rotationally fixed manner and which are spaced apart from one another in the direction of the horizontal axis, preferably in the shape of grinding disks, which move the grinding bodies, whereby, on the outlet side, the agitator shaft has a basket, which is preferably studded with grinding members on its outer circumference and which overlaps the split tube-supporting outlet, whereby the basket has a section with an enlarged outer diameter in the region of its free end, characterized in that on the side facing away from the free end of the basket, the section with the enlarged outer diameter forms a ramp, which runs obliquely to the horizontal and which has a smooth jacket surface, which is intersected by webs and/or apertures.

2. The agitator mill according to claim 1, characterized in that the section with the enlarged outer diameter reaches directly to the free end of the basket.

3. The agitator mill according to claim 1, characterized in that the section with the enlarged outer diameter, including the ramp, which is possibly formed by it, in the direction along the agitator shaft axis, accounts for between 45% and 20%, better between 30% and 25%, of the length of the basket in the direction of the agitator shaft axis.

4. The agitator mill according to claim 1, characterized in that the section with the enlarged outer diameter has a smooth jacket surface outside of the ramp, which is possibly formed by it.

5. The agitator mill according to claim 1, characterized in that on its circumferential jacket surface, the section with the enlarged outer diameter supports grinding members, preferably in the shape of grinding rods, ideally in the shape of at least one ring of grinding rods, which are set up one behind the other in the circumferential direction.

6. The agitator mill according to claim 5, characterized in that the free ends of the grinding members of the agitator shaft end at the same diameter as the remaining grinding members supported by the basket.

7. A basket, formed as a replacement part, which is to be added subsequently, preferably by screwing to an agitator shaft and which is preferably studded with grinding members on its outer circumference and overlaps a split tube-supporting outlet in the assembled position, whereby the basket has a section with an enlarged outer diameter in the region of its free end, characterized in that on the side facing away from the free end of the basket, the section with the enlarged outer diameter forms a ramp, which runs obliquely to the horizontal and which has a smooth jacket surface, which is intersected by webs and/or apertures.

8. The agitator mill according to claim 2, characterized in that the section with the enlarged outer diameter, including the ramp, which is possibly formed by it, in the direction along the agitator shaft axis, accounts for between 45% and 20%, better between 30% and 25%, of the length of the basket in the direction of the agitator shaft axis.

9. The agitator mill according to claim 2, characterized in that the section with the enlarged outer diameter has a smooth jacket surface outside of the ramp, which is possibly formed by it.

10. The agitator mill according to claim 2, characterized in that on its circumferential jacket surface, the section with the enlarged outer diameter supports grinding members, preferably in the shape of grinding rods, ideally in the shape of at least one ring of grinding rods, which are set up one behind the other in the circumferential direction.
